(19) United States
(12) Patent Application Publication
(10) Pub. No.: US 2026/0062550 A1
(43) Pub. Date: Mar. 5, 2026

(54) COPOLYESTER BLOW MOLDED ARTICLES WITH A TRANSPARENT VIEW STRIPE

(71) Applicant: Eastman Chemical Company, Kingsport, TN (US)

(72) Inventors: Marc Alan Strand, Kingsport, TN (US); Katherine Augusta Hofmann, Kingsport, TN (US); Michael W. Cradic, Kingsport, TN (US)

(73) Assignee: Eastman Chemical Company, Kingsport, TN (US)

(21) Appl. No.: 19/107,070

(22) PCT Filed: Aug. 30, 2023
(86) PCT No.: PCT/US2023/073122

§ 371 Date: Feb. 27, 2025

Related U.S. Application Data
(60) Provisional application No. 63/374,638, filed on Sep. 6, 2022.

(51) Int. Cl. C08L 67/02; B32B 1/00; B32B 27/08; B32B 27/36; B65D 1/02; B65D 23/00; B65D 25/54; B65D 65/38; C08G 63/199

(52) U.S. Cl. CPC C08L 67/02; B32B 1/00; B32B 27/08; B32B 27/36; B65D 1/0215; B65D 23/00; B65D 25/54; B65D 65/38; C08G 63/199; B32B 2250/02; B32B 2250/244; B32B 2305/70; B32B 2307/41; B32B 2307/412; B32B 2439/60; B65D 2565/384; C08L 2201/10; C08L 2203/10; C08L 2203/16; C08L 2205/025; C08L 2207/20

(57) ABSTRACT

Blow molded articles with transparent view stripes made from copolyester compositions which comprise residues of terephthalic acid, 1,4-cyclohexanedimethanol (CHDM), ethylene glycol (EG), neopentyl glycol (NPG), and/or 2,2,4,4-tetramethyl-1,3-cyclobutanediol (TMCD) residues, in certain compositional ranges having certain advantages and improved properties.

### FIELD OF THE INVENTION

The present disclosure relates to blow molded articles made from copolyester compositions which comprise residues of terephthalic acid, 1,4-cyclohexanedimethanol (CHDM), ethylene glycol (EG), neopentyl glycol (NPG), and/or 2,2,4,4-tetramethyl-1,3-cyclobutanediol (TMCD) residues, in certain compositional ranges having certain advantages and improved properties. More particularly, the present disclosure pertains to blow molded articles made from copolyesters that comprise a transparent view stripe.

### BACKGROUND OF THE INVENTION

Historically, opaque extrusion blow molded articles with clear view stripes are made mostly from polymers such as polyolefins and styrene-based polymers. The packaging market, however, is currently moving towards making these types of articles made from polyesters rather than other polymers such as polypropylene (PP) or high-density polyethylene (HDPE) and styrene. In this disclosure polyester compositions have been discovered that can replace PP/HDPE and styrene in extrusion blow molded articles that are mostly opaque with a clear viewing stripe.

This trend is due to requirements to increase the recycle content in packaging articles and/or to make them more recyclable to avoid landfills or incineration. In addition, the use of polyesters can bring enhanced aesthetic and physical properties to these articles and containers. Typically, PP and HDPE containers lack good aesthetics. They often have dull surfaces, and the clear view stripe is often hazy.

Opaque containers with clear view stripes are often made by extrusion blow molding processes. The extrusion blow molding process needs increased melt strength compared to polyesters such as PET that are often used in soft drink and water bottles. In some applications, these types of extrusion blow molded articles must enable containers that provide a UV barrier and dishwasher compatibility. These requirements limit the polyester compositions that are viable.

Physical requirements for this specific application are that the bottle must pass a drop test when filled with liquid, must have good aesthetics (high gloss surface, clear/transparent/no haze view stripe).

The present disclosure addresses a long felt commercial need for blow molded articles produced from copolyester thermoplastic materials with clear side view panels that have the following desired properties: (1) increased melt strength, (2) good processibility, (3) good impact properties and/or toughness, (4) good aesthetics, and in some applications (5) dishwasher compatibility, and (6) UV barrier properties. Good aesthetics are measured by side view stripes with high gloss surfaces, high clarity, and that are clear/transparent with low haze. It is also desirable that these articles are made from materials that can be readily recycled, contain recycled material, and/or be made with materials that are not considered to be harmful to the environment either as a raw material or as final polymeric materials (styrene, polystyrene, polyolefins, etc.), as is the case with polyesters.

### BRIEF SUMMARY OF THE INVENTION

One embodiment of the present disclosure is a multi-layer extrusion blow molded article with a transparent view panel which comprises at least one opaque layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of 1,4-cyclohexanedimethanol; and
   (iii) 0 to 10 mole % residues of other modifying glycols chosen from one or more of the following diethylene glycol, NPG, TMCD, MPDiol, isosorbide, butanediol, propanediol;
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10wt %; and
wherein the total mole % of the dicarboxylic acid component is 100 mole %, and wherein the total mole % of the glycol component is 100 mole %;
and wherein the inherent viscosity of the polyester is from 0.50 to 1.30 dL/g as determined in 60/40 (wt/wt) phenol/tetrachloroethane at a concentration of 0.25 g/50 ml at 25° C.; and
at least one transparent layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of 1,4-cyclohexanedimethanol; and
   (iii) 0 to 10 mole % residues of other modifying glycols chosen from one or more of the following diethylene glycol, NPG, TMCD, MPDiol, isosorbide, butanediol, propanediol;
(c) optionally, at least one branching agent in the amount of 0 to 1.0 mole %; and
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; and wherein said transparent view panel has a haze value of less than 10%, when measured on a film 16 mils thick, as measured by ASTM D1003, Method A.

One embodiment of the present disclosure is a multi-layer extrusion blow molded article with a transparent view panel which comprises at least one opaque layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of TMCD; and
   (iii) 0 to 10 mole % residues of other modifying glycols chosen from one or more of the following diethylene glycol, NPG, CHDM, MPDiol, isosorbide, butane diol, propane diol;
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %;
and wherein the inherent viscosity of the polyester is from 0.50 to 1.30 dL/g as determined in 60/40 (wt/wt) phenol/tetrachloroethane at a concentration of 0.25 g/50 ml at 25° C.; and
at least one transparent layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of TMCD; and
   (iii) 0 to 10 mole % residues of other modifying glycols chosen from one or more of the following diethylene glycol, NPG, CHDM, MPDiol, isosorbide, butanediol, propanediol;
(c) optionally, at least one branching agent in the amount of 0 to 1.0 mole %;
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; wherein said article is opaque and has a transparent view panel and wherein said transparent view panel has a haze value of less than 10%, when measured on a film 16 mils thick, as measured by ASTM D1003, Method A.

One embodiment of the present disclosure is a multi-layer extrusion blow molded article with a transparent view panel which comprises at least one opaque layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising (consisting essentially of):
   (i) 25 to 100 mole % CHDM residues; and
   (ii) 0 to 75 mole % residues of TMCD; and
   (iii) 0 to 10 mole % residues of other modifying glycols chosen from one or more of the following ethylene glycol, diethylene glycol, NPG, TMCD, MPDiol, isosorbide, butanediol, propanediol;
(c) optionally, at least one branching agent in the amount of 0 to 1.0 mole %;
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %;
and wherein the inherent viscosity of the polyester is from 0.50 to 1.30 dL/g as determined in 60/40 (wt/wt) phenol/tetrachloroethane at a concentration of 0.25 g/50 ml at 25° C.; and
   at least one transparent layer which comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % CHDM residues; and
   (ii) 0 to 75 mole % residues of TMCD; and
   (iii) 0 to 10 mole % residues of other modifying glycols chosen from one or more of the following ethylene glycol, diethylene glycol, NPG, TMCD, MPDiol, isosorbide, butane diol, propane diol;
(c) optionally, at least one branching agent in the amount of 0 to 1.0 mole %;
wherein the total mole % of the dicarboxylic acid component is 100 mole %, and
wherein the total mole % of the glycol component is 100 mole %; and
   wherein the inherent viscosity of the polyester is from 0.50 to 1.30 dL/g as determined in 60/40 (wt/wt) phenol/tetrachloroethane at a concentration of 0.25 g/50 ml at 25° C.; and wherein said transparent view panel has a haze value of less than 10%, when measured on a film 16 mils thick, as measured by ASTM D1003, Method A.

One embodiment of the present disclosure is a multi-layer extrusion blow molded container comprising a cavity that is configured and adapted to hold liquid, the container having a horizontal perimeter and comprising an opaque wall portion and transparent wall portion, the opaque wall portion comprising at least one layer extending a majority of the way around the perimeter and bounding a main portion of the cavity, the transparent wall portion comprising at least one layer extending beyond the opaque wall portion and vertically along the opaque wall portion of the container in a manner such that liquid in the cavity can be observed through the transparent wall portion said at least one opaque layer comprises at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of 1,4-cyclohexanedimethanol; and
   (iii) 0 to 10 mole % residues of other modifying glycols chosen from one or more of the following diethylene glycol, NPG, TMCD, MPDiol, isosorbide, butanediol, propanediol; or
(b′) a glycol component comprising (consisting essentially of):
   (i) 25 to 100 mole % ethylene glycol residues; and
   (ii) 0 to 75 mole % residues of TMCD; and
   (iii) 0 to 10 mole % residues of other modifying glycols chosen from one or more of the following diethylene glycol, NPG, CHDM, MPDiol, isosorbide, butanediol, propanediol; or
(b″) a glycol component comprising or consisting essentially of:
   (i) 25 to 100 mole % CHDM residues; and
   (ii) 0 to 75 mole % residues of TMCD; and
   (iii) 0 to 10 mole % residues of other modifying glycols chosen from one or more of the following ethylene glycol, diethylene glycol, NPG, TMCD, MPDiol, isosorbide, butanediol, propanediol; and
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10wt %; and
wherein the total mole % of the dicarboxylic acid component is 100 mole %, and wherein the total mole % of the glycol component is 100 mole %; and wherein the inherent viscosity of the polyester is from 0.50 to 1.30 dL/g as determined in 60/40 (wt/wt) phenol/tetrachloroethane at a concentration of 0.25 g/50 ml at 25° C.; and wherein the Tg of the polyester is from 80° C. or greater;
and
said at least one transparent layer comprising at least one polyester composition comprising:
(a) a dicarboxylic acid component comprising:
   (i) about 90 to about 100 mole % of terephthalic acid residues;
   (ii) about 0 to about 10 mole % of aromatic and/or aliphatic dicarboxylic acid residues having up to 20 carbon atoms; and
(b) a glycol component comprising or consisting essentially of:
   (i) 25 to 100 mole % ethylene glycol residues; and
   (ii) 0 to 75 mole % residues of 1,4-cyclohexanedimethanol; and
   (iii) 0 to 10 mole % residues of other modifying glycols chosen from one or more of the following diethylene glycol, NPG, TMCD, MPDiol, isosorbide, butanediol, propanediol; or
(b′) a glycol component comprising or consisting essentially of:
   (i) 25 to 100 mole % ethylene glycol residues; and
   (ii) 0 to 75 mole % residues of TMCD; and
   (iii) 0 to 10 mole % residues of other modifying glycols chosen from one or more of the following diethylene glycol, NPG, CHDM, MPDiol, isosorbide, butanediol, propanediol; or
(b″) a glycol component comprising or consisting essentially of:
   (i) 25 to 100 mole % CHDM residues; and
   (ii) 0 to 75 mole % residues of TMCD; and
   (iii) 0 to 10 mole % residues of other modifying glycols chosen from one or more of the following ethylene glycol, diethylene glycol, NPG, TMCD, MPDiol, isosorbide, butanediol, propanediol;
(c) optionally, at least one branching agent in the amount of 0 to 1.0 mole %; and
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; and wherein said transparent view panel has a haze value of less than 10%, when measured on a film 16 mils thick, as measured by ASTM D1003, Method A; and wherein the Tg of the polyester is from 80° C. or greater.

In one aspect, the articles of the present disclosure are recyclable in a PET recycle stream.

In one embodiment, the articles of the present disclosure are useful as molded articles, hot-filled containers, containers, packaging articles, jars, through handle bottles, containers and jugs, appliance parts, cosmetic jars, bottles, medical containers, personal care containers, cosmetics containers, molded articles, lids, medical devices, medical packaging, healthcare supplies, commercial foodservice products, containers, tumblers, storage boxes, bottles, water bottles, or any article designed to hold liquids.

### DETAILED DESCRIPTION

The present disclosure may be understood more readily by reference to the following detailed description of certain embodiments of the disclosure and the working examples. In accordance with the purpose(s) of this disclosure, certain embodiments of the disclosure are described in the Summary of the Invention and are further described herein below. Also, other embodiments of the disclosure are described herein.

Extrusion blow molding is a common process for creating hollow articles from polymeric materials. A typical extrusion blow-molding manufacturing process involves: 1) melting the resin in an extruder; 2) extruding the molten resin through a die to form a parison having a uniform wall thickness; 3) clamping a mold having the desired finished shape around the parison; 4) blowing air into the parison, causing the extrudate to stretch and expand to fill the mold; 5) cooling the molded article; and 6) ejecting the article from the mold.

The hollow articles generated by extrusion blow molding are often used to contain solid or liquid products. The container must, therefore, be sufficiently tough to protect the product and prevent it from leaking or spilling after an accidental drop or impact. Toughness of the blow molded article is related to several factors, including part design, wall thickness, size of the container, and material. For filled articles, size of the container affects toughness greatly, as the weight of the contents produces the impact weight. Larger containers will hold heavier masses that will produce a higher impact load. In order to compensate for these higher impact loads, wall thickness must be increased or a tougher material must be selected. Unfortunately, it is not always possible to increase wall thickness due to melt strength limitations and cost. Thus, the preferred solution is usually to extrusion blow mold the containers from a tougher material.

In one aspect the present disclosure pertains to articles that are recyclable in a PET stream. In 2017, California Assembly Bill No. 906—Beverage containers: polyethylene terephthalate was signed into law, and it defines “polyethylene terephthalate” (PET) for purposes of resin code labeling as a plastic that meets certain conditions, including limits with respect to the chemical composition of the polymer and a melting peak temperature within a specified range. AB-906 adds Section 18013 to California's Public Resources Code, which reads, in part:

“Polyethylene terephthalate (PET)” means a plastic derived from a reaction between terephthalic acid or dimethyl terephthalate and monoethylene glycol as to which both of the following conditions are satisfied:
a. The terephthalic acid or dimethyl terephthalate and monoethylene glycol reacted constitutes at least 90 percent of the mass of the monomer reacted to form the polymer.
b. The plastic exhibits a melting peak temperature that is between 225 degrees Celsius and 255 degrees Celsius, as determined during the second thermal scan using procedure 10.1 as set forth in ASTM International (ASTM) D3418 with a heating rate of a sample at 10 degrees Celsius per minute.”

As such, copolyesters, and blends of the aforementioned which meet both of the conditions outlined in AB-906, are acceptable for being called “PET”, and thus such materials are likely to be compatible in current PET recycle streams. The melting points of the blend compositions in the present disclosure make them acceptable under this definition as PET, and thus, compatible in the current PET recycle streams.

During the recycling process, drying of the PET flake is required to remove residual water that remains with the PET through the recycling process. Typically, PET is dried at temperatures above 200° C. At those temperatures, typical copolyester resins will soften and become sticky, often creating clumps with PET flakes. These clumps must be removed before further processing. These clumps reduce the yield of PET flake from the process and create an additional handling step.

Also, it has been found that certain combinations of glycol monomers in resin compositions can produce articles with good performance properties and that are also crystallizable such that it does not impact the recycling of the PET flake. These articles can be processed with recycled PET and end up as a component in the recyclable PET flake leaving the recycling process.

The term “container” as used herein is understood to mean a receptacle in which material is held or stored. Containers include but are not limited to bottles, bags, vials, tubes, cans, and jars. Applications in the industry for these types of containers include but are not limited to medical, automotive, food, beverage, cosmetics, and personal care applications.

The term “bottle” as used herein is understood to mean a receptacle containing plastic which is capable of storing or holding liquid.

In one embodiment, the present disclosure produces bottles containing a through-handle produced an extrusion blow molding (EBM) process.

In one aspect, the present disclosure is useful as containers and bottles for various applications, such as, cosmetics including make-up, liquids and creams; personal care; household detergents; hair care products including shampoos and conditioners; cleaning supplies; lotions; soaps; automotive fluids including oil and antifreeze; food and cooking supplies including olive oils, spices, cooking oils, vegetable oils, soups, sauces, creams, and condiments; beverages; sports drinks; water bottles; juices; and milk.

The term “polyester”, as used herein, is intended to include “copolyesters” and is understood to mean a synthetic polymer prepared by the reaction of one or more difunctional carboxylic acids and/or multifunctional carboxylic acids with one or more difunctional hydroxyl compounds and/or multifunctional hydroxyl compounds, for example, branching agents. Typically, the difunctional carboxylic acid can be a dicarboxylic acid and the difunctional hydroxyl compound can be a dihydric alcohol, for example, glycols and diols. The term “glycol” as used herein includes, but is not limited to, diols, glycols, and/or multifunctional hydroxyl compounds, for example, branching agents. Alternatively, the difunctional carboxylic acid may be a hydroxy carboxylic acid, for example, p-hydroxybenzoic acid, and the difunctional hydroxyl compound may have an aromatic nucleus bearing 2 hydroxyl substituents, for example, hydroquinone. The term “residue”, as used herein, means any organic structure incorporated into a polymer through a polycondensation and/or an esterification reaction from the corresponding monomer. The term “repeating unit”, as used herein, means an organic structure having a dicarboxylic acid residue and a diol residue bonded through an ester group. Thus, for example, the dicarboxylic acid residues may be derived from a dicarboxylic acid monomer or its associated acid halides, esters, salts, anhydrides, and/or mixtures thereof. Furthermore, as used herein, the term “diacid” includes multifunctional acids, for example, branching agents. As used herein, therefore, the term “dicarboxylic acid” is intended to include dicarboxylic acids and any derivative of a dicarboxylic acid, including its associated acid halides, esters, half-esters, salts, half-salts, anhydrides, mixed anhydrides, and/or mixtures thereof, useful in a reaction process with a diol to make a polyester. As used herein, the term “terephthalic acid” is intended to include terephthalic acid itself and residues thereof as well as any derivative of terephthalic acid, including its associated acid halides, esters, half-esters, salts, half-salts, anhydrides, mixed anhydrides, and/or mixtures thereof or residues thereof useful in a reaction process with a diol to make a polyester.

The polyesters used in the present disclosure typically can be prepared from dicarboxylic acids and diols which react in substantially equal proportions and are incorporated into the polyester polymer as their corresponding residues. The polyesters of the present disclosure, therefore, can contain substantially equal molar proportions of acid residues (100 mole %) and diol (and/or multifunctional hydroxyl compound) residues (100 mole %) such that the total moles of repeating units is equal to 100 mole %. The mole percentages provided in the present disclosure, therefore, may be based on the total moles of acid residues, the total moles of diol residues, or the total moles of repeating units. For example, a polyester containing 10 mole % isophthalic acid, based on the total acid residues, means the polyester contains 10 mole % isophthalic acid residues out of a total of 100 mole % acid residues. Thus, there are 10 moles of isophthalic acid residues among every 100 moles of acid residues. In another example, a polyester containing 25 mole % 1,4-cyclohexanedimethanol, based on the total diol residues, means the polyester contains 25 mole % 1,4-cyclohexanedimethanol residues out of a total of 100 mole % diol residues. Thus, there are 25 moles of 1,4-cyclohexanedimethanol residues among every 100 moles of diol residues.

In certain embodiments, terephthalic acid or an ester thereof, for example, dimethyl terephthalate or a mixture of terephthalic acid residues and an ester thereof can make up a portion or all of the dicarboxylic acid component used to form the polyesters useful in the present disclosure. In certain embodiments, terephthalic acid residues can make up a portion or all of the dicarboxylic acid component used to form the polyesters useful in this disclosure. For the purposes of this disclosure, the terms “terephthalic acid” and “dimethyl terephthalate” are used interchangeably herein. In one embodiment, dimethyl terephthalate is part or all of the dicarboxylic acid component used to make the polyesters useful in the present disclosure. In embodiments, ranges of from 70 to 100 mole %; or 80 to 100 mole %; or 90 to 100 mole %; or 99 to 100 mole %; or 100 mole % terephthalic acid and/or dimethyl terephthalate and/or mixtures thereof may be used.

In addition to terephthalic acid, the dicarboxylic acid component of the polyesters useful in the present disclosure can comprise up to 30 mole %, up to 20 mole %, up to 10 mole %, up to 5 mole %, or up to 1 mole % of one or more modifying aromatic dicarboxylic acids. Yet another embodiment contains 0 mole % modifying aromatic dicarboxylic acids. Thus, if present, it is contemplated that the amount of one or more modifying aromatic dicarboxylic acids can range from any of these preceding endpoint values including, for example, 0.01 to 10 mole %, from 0.01 to 5 mole % and from 0.01 to 1 mole %. In one embodiment, modifying aromatic dicarboxylic acids that may be used in the present disclosure include but are not limited to those having up to 20 carbon atoms, and which can be linear, para-oriented, or symmetrical. Examples of modifying aromatic dicarboxylic acids which may be used in this disclosure include, but are not limited to, isophthalic acid, 4,4′-biphenyldicarboxylic acid, 1,4-, 1,5-, 2,6-, 2,7-naphthalenedicarboxylic acid, and trans-4,4′-stilbenedicarboxylic acid, and esters thereof. In one embodiment, the modifying aromatic dicarboxylic acid is isophthalic acid.

The carboxylic acid component of the polyesters useful in the present disclosure can be further modified with up to 10 mole %, such as up to 5 mole % or up to 1 mole % of one or more aliphatic dicarboxylic acids containing 2-16 carbon atoms, for example, cyclohexanedicarboxylic, malonic, succinic, glutaric, adipic, pimelic, suberic, azelaic and/or dodecanedioic dicarboxylic acids. Certain embodiments can also comprise 0.01 to 10 mole %, such as 0.1 to 10 mole %, 1 or 10 mole %, 5 to 10 mole % of one or more modifying aliphatic dicarboxylic acids. Yet another embodiment contains 0 mole % modifying aliphatic dicarboxylic acids. The total mole % of the dicarboxylic acid component is 100 mole %. In one embodiment, adipic acid and/or glutaric acid are provided in the modifying aliphatic dicarboxylic acid component of the polyesters and are useful in the present disclosure.

Esters of terephthalic acid and the other modifying dicarboxylic acids or their corresponding esters and/or salts may be used instead of the dicarboxylic acids. Suitable examples of dicarboxylic acid esters include, but are not limited to, the dimethyl, diethyl, dipropyl, diisopropyl, dibutyl, and diphenyl esters. In one embodiment, the esters are chosen from at least one of the following: methyl, ethyl, propyl, isopropyl, and phenyl esters.

In one embodiment, at least a portion of the residues derived from dicarboxylic acids and glycols as set forth herein, are derived from recycled monomeric species such as recycled dimethylterephthalate (rDMT), recycled terephthalic acid (rTPA), recycled dimethylisopthalate (rDMI), recycled ethylene glycol (rEG), recycled cyclohexanedimethanol (rCHDM), recycled neopentyl glycol (rNPG), and recycled diethylene glycol (rDEG). Such recycled monomeric species can be obtained from known methanolysis or glycolysis reactions which are utilized to depolymerize various post-consumer recycled polyesters and copolyesters. Similarly, recycled poly(ethylene terephthalate) (rPET) can be utilized as a feedstock (for the dicarboxylic acid and glycol components) in the manufacturing of polyesters of the present disclosure having recycle content. Accordingly, in another embodiment, the polyester compositions of this disclosure comprise at least a portion of the dicarboxylic acid residues and/or glycol residues are derived from (i) recycled monomeric species chosen from rDMT, rTPA, rDMI, rEG, rCHDM, rDEG, INPG and (ii) rPET.

In embodiments, compositions that are useful as polyester reactants or intermediates in a reaction scheme to provide a recycle content containing copolyester product. In embodiments, these recycle content compositions derive their recycle content from r-propylene which, in turn, derives its recycle content from r-pyoil. In embodiments, such recycle content compositions can be chosen from r-isobutyraldehyde, r-isobutyric acid, r-isobutyric anhydride, r-dimethyl ketene, rTMCDn or r-TMCD.

In one embodiment, the glycol component of the copolyester compositions useful in the present disclosure can comprise 1,4-cyclohexanedimethanol. In another embodiment, the glycol component of the copolyesters compositions useful in the present disclosure comprise 1,4-cyclohexanedimethanol and 1,3-cyclohexanedimethanol. The molar ratio of cis/trans 1,4-cyclohexandimethanol can vary within the range of 50/50 to 0/100, for example, between 40/60 to 20/80.

In one embodiment, the total comonomer from glycols and acids other than ethylene glycol (EG), terephthalic acid (TPA), or dimethyl terephthalate (DMT) of the copolyester compositions useful in the present disclosure is from 5 to 15 wt %, or from 5 to 10 wt %, or from 10 to 15 wt %, or from 2 to 15 wt %, or from 2 to 10 wt %, or from 3 to 15 wt %, or from 3 to 10 wt %, or from 4 to 15 wt %, or from 4 to 10 wt %, or from 6 to 15 wt %, or from 6 to 10 wt %, or from 7 to 15 wt %, or from 7 to 10 wt %, or from 8 to 15 wt %, or from 8 to 10 wt %, or from 9 to 15 wt %, or from 9 to 10 wt %, or from 11 to 15 wt %, 12 to 15 wt %, or from 13 to 15 wt %, 14 to 15 wt %, or from 12 to 16 wt %.

In one embodiment, the glycol component of the copolyester compositions useful in this disclosure can contain 0 to 10 mole % of neopentyl glycol based on the total mole % of the glycol component being 100 mole %. In one embodiment, the glycol component of the copolyester compositions useful in this disclosure can contain 0 to 5 mole % of neopentyl glycol based on the total mole % of the glycol component being 100 mole %. In one embodiment, the glycol component of the copolyester compositions useful in this disclosure can contain 5 to 10 mole % of neopentyl glycol based on the total mole % of the glycol component being 100 mole %. In one embodiment, the glycol component of the copolyester compositions useful in this disclosure can contain 1 to 5 mole % of neopentyl glycol based on the total mole % of the glycol component being 100 mole %. In one embodiment, the glycol component of the copolyesters compositions useful in this disclosure can contain 2 to 5 mole % of neopentyl glycol based on the total mole % of the glycol component being 100 mole %. In one embodiment, the glycol component of the copolyesters compositions useful in this disclosure can contain 3 to 5 mole % of neopentyl glycol based on the total mole % of the glycol component being 100 mole %.

In one embodiment, the glycol component of the copolyesters compositions useful in this disclosure can contain from 0 to 10 mole %, 0 to 5 mole %, or from 0 to 4 mole %, or from 0 to 3 mole %, or from 0 to 2 mole %, or from 0 to 1 mole %, or from 0.01 to 5 mole %, or from 0.01 to 4 mole %, or from 0.01 to 3 mole %, or from 0.01 to 2 mole %, or from 0.01 to 1 mole %, or from 1 to 10 mole %, 1 to 5 mole %, or from 2 to 5 mole %, or from 3 to 5 mole %, or from 4 to 5 mole %, or from 2 to 4 mole %, or 3 to 4 mole %, or from 1 to 4 mole %, 1 to 3 mole %, or from 1 to 2 mole %, or from 2 to 3 mole %, or from 2 to 5 mole %, or from 2 to 4 mole %, or 2 to 3 mole % 3 to 10 mole %, or from 3 to 9 mole %, or from 3 to 8 mole %, or from 3 to 7 mole %, or from 2 to 10 mole %, or from 2 to 9 mole %, or from 2 to 8 mole %, or from 2 to 7 mole %, or from 2 to 5 mole %, or from 1 to 7 mole %, or from 1 to 5 mole %, or from 1 to 3 mole %, of neopentyl glycol residues, based on the total mole % of the glycol component being 100 mole %.

In one embodiment, the glycol component of the copolyester compositions useful in this disclosure can contain from 0 to 75 mole % of 1,4-cyclohexanedimethanol based on the total mole % of the glycol component being 100 mole %. In one embodiment, the glycol component of the copolyester compositions useful in this disclosure can contain 0.01 to less than 75 mole % of 1,4-cyclohexanedimethanol based on the total mole % of the glycol component being 100 mole %. In one embodiment, the glycol component of the copolyester compositions useful in this disclosure can contain 0 to 50 mole % of 1,4-cyclohexanedimethanol based on the total mole % of the glycol component being 100 mole %. In one embodiment, the glycol component of the copolyester compositions useful in this disclosure can contain 0.01 to less than 50 mole % of 1,4-cyclohexanedimethanol based on the total mole % of the glycol component being 100 mole %. In one embodiment, the glycol component of the copolyester compositions useful in this disclosure can contain 0.01 to 30 mole % of 1,4-cyclohexanedimethanol based on the total mole % of the glycol component being 100 mole %. In one embodiment, the glycol component of the copolyester compositions useful in this disclosure can contain 0.01 to less than 25 mole % of 1,4-cyclohexanedimethanol based on the total mole % of the glycol component being 100 mole %. In one embodiment, the glycol component of the copolyester compositions useful in this disclosure can contain 25 to 100 mole % of 1,4-cyclohexanedimethanol based on the total mole % of the glycol component being 100 mole %.

In one embodiment, the glycol component of the copolyester compositions useful in this disclosure can contain from 0 to 75 mole %, or from 0 to 50 mole %, or from 0 to 40 mole %, or from 0 to 30 mole %, or from 0 to 25 mole %, or from 0 to 20 mole %, or from 0 to 10 mole %, or from 0.01 to 75 mole %, or from 0.01 to 50 mole %, or from 0.01 to 40 mole %, or from 0.01 to 30 mole %, or from 0.01 to 20 mole %, or from 0.01 to 15 mole %, or from 0.01 to 14 mole %, or from 0.01 to 13 mole %, or from 0.01 to 12 mole %, or from 0.01 to 11 mole %, or 0.01 to 10 mole %, or from 0.01 to 9 mole %, or from 0.01 to 8 mole %, or from 0.01 to 7 mole %, or from 0.01 to 6 mole %, or from 0.01 to 5 mole %, or from 0.1 to 50 mole %, or from 0.1 to 40 mole %, or from 0.1 to 30 mole %, or from 0.1 to 20 mole %, or from 0.1 to 10 mole %, or from 25 to 100 mole %, or from 25 to 75 mole %, or from 25 to 50 mole %, or from 5 to 50 mole %, 10 to 50 mole %, or from 20 to 50 mole %, or from 30 to 50 mole %, or from 40 to 50 mole %, or from 20 to 40 mole %, or 30 to 40 mole %, or from 10 to 40 mole %, 10 to 30 mole %, or from 10 to 20 mole %, or from 20 to 30 mole %, or from 2 to 50 mole %, or from 2 to 40 mole %, or 2 to 30 mole %, or from 2 to 20 mole %, 3 to 15 mole %, or from 3 to 14 mole %, or from 3 to 13 mole %, or from 3 to 12 mole %, or from 3 to 11 mole %, or 3 to 10 mole %, or from 3 to 9 mole %, or from 3 to 8 mole %, or from 3 to 7 mole %, or from 2 to 10 mole %, or from 2 to 9 mole %, or from 2 to 8 mole %, or from 2 to 7 mole %, or from 2 to 5 mole %, or from 1 to 7 mole %, or from 1 to 5 mole %, or from 1 to 3 mole %, 1,4-cyclohexanedimethanol residues, based on the total mole % of the glycol component being 100 mole %.

In one embodiment, the glycol component of the copolyester compositions useful in this disclosure can contain from 0 to 75 mole %, or from 0 to 35 mole %, or from 0 to 30 mole %, or from 0 to 25 mole %, or from 0 to 20 mole %, or from 0 to 10 mole %, or from 0.01 to 35 mole %, or from 0.01 to 30 mole %, or from 0.01 to 25 mole %, or from 0.01 to 20 mole %, or from 0.01 to 15 mole %, or from 0.01 to 14 mole %, or from 0.01 to 13 mole %, or from 0.01 to 12 mole %, or from 0.01 to 11 mole %, or 0.01 to 10 mole %, or from 0.01 to 9 mole %, or from 0.01 to 8 mole %, or from 0.01 to 7 mole %, or from 0.01 to 6 mole %, or from 0.01 to 5 mole %, or from 0.1 to 35 mole %, or from 0.1 to 30 mole %, or from 0.1 to 25 mole %, or from 0.1 to 20 mole %, or from 0.1 to 10 mole %, or from 5 to 35 mole %, 10 to 35 mole %, or from 20 to 35 mole %, or from 25 to 35 mole %, 10 to 30 mole %, or from 10 to 20 mole %, or from 20 to 30 mole %, or from 2 to 35 mole %, or from 2 to 25 mole %, or 2 to 30 mole %, or from 2 to 20 mole %, 3 to 15 mole %, or from 3 to 14 mole %, or from 3 to 13 mole %, or from 3 to 12 mole %, or from 3 to 11 mole %, or 3 to 10 mole %, or from 3 to 9 mole %, or from 3 to 8 mole %, or from 3 to 7 mole %, or from 2 to 10 mole %, or from 2 to 9 mole %, or from 2 to 8 mole %, or from 2 to 7 mole %, or from 2 to 5 mole %, or from 1 to 7 mole %, or from 1 to 5 mole %, or from 1 to 3 mole %, of 2,2,4,4-tetramethyl-1,3-cyclobutanediol residues, based on the total mole % of the glycol component being 100 mole %.

In one embodiment, the glycol component of the copolyester compositions useful in this disclosure can contain 0 to 75 mole % of 2,2,4,4-tetramethyl-1,3-cyclobutanediol based on the total mole % of the glycol component being 100 mole %. In one embodiment, the glycol component of the copolyester compositions useful in this disclosure can contain 0.01 to less than 75 mole % of 2,2,4,4-tetramethyl-1,3-cyclobutanediol based on the total mole % of the glycol component being 100 mole %. In one embodiment, the glycol component of the copolyester compositions useful in this disclosure can contain 0 to 30 mole % of 2,2,4,4-tetramethyl-1,3-cyclobutanediol based on the total mole % of the glycol component being 100 mole %. In one embodiment, the glycol component of the copolyester compositions useful in this disclosure can contain 0.01 to less than 30 mole % of 2,2,4,4-tetramethyl-1,3-cyclobutanediol based on the total mole % of the glycol component being 100 mole %. In one embodiment, the glycol component of the copolyester compositions useful in this disclosure can contain 0.01 to 25 mole % of 2,2,4,4-tetramethyl-1,3-cyclobutanediol based on the total mole % of the glycol component being 100 mole %. In one embodiment, the glycol component of the copolyester compositions useful in this disclosure can contain 0 to less than 25 mole % of 2,2,4,4-tetramethyl-1,3-cyclobutanediol based on the total mole % of the glycol component being 100 mole %.

It should be understood that some other glycol residues may be formed in situ during processing. The total amount of diethylene glycol residues can be present in the copolyesters useful in the present disclosure, whether or not formed in situ during processing or intentionally added, or both, in any amount, for example, from 1 to 10 mole %, or from 2 to 10 mole %, or from 2 to 9 mole %, or from 3 to 9 mole %, or from 3 to 10 mole %, or 3 to 9 mole %, or from 3 to 8 mole %, or from 4 to 10 mole %, or from 4 to 9 mole %, or 4 to 8 mole %, or from 4 to 7 mole %, or, from 5 to 10 mole %, or from 5 to 9 mole %, or 5 to 8 mole %, or from 5 to 7 mole %, of diethylene glycol residues, based on the total mole % of the glycol component being 100 mole %.

In one embodiment, the total amount of diethylene glycol residues present in the copolyesters useful in the present disclosure, whether or not formed in situ during processing or intentionally added or both, can be from 5 mole % or less, or 4 mole % or less, or from 3.5 mole % or less, or from 3.0 mole % or less, or from 2.5 mole % or less, or from 2.0 mole % or less, or from 1.5 mole % or less, or from 1.0 mole % or less, or from 1 to 4 mole %, or from 1 to 3 mole %, or from 1 to 2 mole % of diethylene glycol residues, or from 2 to 8 mole %, or from 2 to 7 mole %, or from 2 to 6 mole %, or from 2 to 5 mole %, or from 3 to 8 mole %, or from 3 to 7 mole %, or from 3 to 6 mole %, or from 3 to 5 mole %, or in some embodiments there is no intentionally added diethylene glycol residues, based on the total mole % of the glycol component being 100 mole %. In certain embodiments, the copolyester contains no added modifying glycols. In certain embodiments, the diethylene glycol residues in copolyesters can be from 5 mole % or less.

For all embodiments, the remainder of the glycol component can comprise ethylene glycol residues in any amount based on the total mole % of the glycol component being 100 mole %. In one embodiment, the copolyesters useful in the present disclosure can contain 50 mole % or greater, or 55 mole % or greater, or 60 mole % or greater, or 65 mole % or greater, or 70 mole % or greater, or 75 mole % or greater, or 80 mole % or greater, or 85 mole % or greater, or 90 mole % or greater, or 95 mole % or greater, or 98 mole % or greater or from 50 to 90 mole %, or from 55 to 90 mole %, or from 50 to 80 mole %, or from 55 to 80 mole %, or from 60 to 80 mole %, or from 50 to 75 mole %, or from 55 to 75 mole %, or from 60 to 75 mole %, or from 65 to 75 mole % of ethylene glycol residues, based on the total mole % of the glycol component being 100 mole %.

In one embodiment, the glycol component of the copolyester compositions useful in the present disclosure can contain up to 10 mole %, or up to 9 mole %, or up to 8 mole %, or up to 7 mole %, or up to 6 mole %, or up to 5 mole %, or up to 4 mole %, or up to 3 mole %, or up to 2 mole %, or up to 1 mole %, or less of one or more other modifying glycols (other modifying glycols are defined as glycols which are not ethylene glycol, diethylene glycol, neopentyl glycol, or 1,4-cyclohexanedimethanol). In certain embodiments, the copolyesters useful in this disclosure can contain 10 mole % or less of one or more other modifying glycols; 5 mole % or less of one or more other modifying glycols; 2mole % or less of one or more other modifying glycols; 1 mole % or less of one or more other modifying glycols. In certain embodiments, the copolyesters useful in this disclosure can contain 5 mole % or less of one or more other modifying glycols. In certain embodiments, the copolyesters useful in this disclosure can contain 3 mole % or less of one or more other modifying glycols. In another embodiment, the copolyesters useful in this disclosure can contain 0 mole % of other modifying glycols. It is contemplated, however, that some other glycol residuals may form in situ so that residual amounts formed in situ are also an embodiment of this disclosure.

In embodiments, the other modifying glycols for use in the copolyesters, if used, as defined herein contain 2 to 16 carbon atoms. Examples of other modifying glycols include, but are not limited to, 1,2-propanediol, 1,3-propanediol, isosorbide, 1,4-butanediol, 1,5-pentanediol, 2-methyl-1,3-propanediol (MPDiol), 1,6-hexanediol, p-xylene glycol, polytetramethylene glycol, 2,2,4,4-tetramethyl-1,3-cyclobutanediol (TMCD) and mixtures thereof. In one embodiment, isosorbide is an other modifying glycol. In another embodiment, the other modifying glycols include, but are not limited to, at least one of 1,3-propanediol and 1,4-butanediol. In one embodiment, 1,3-propanediol and/or 1,4-butanediol can be excluded. If 1,4- or 1,3-butanediol are used, greater than 4 mole % or greater than 5 mole % can be provided in one embodiment. In one embodiment, at least one other modifying glycol is 1,4-butanediol which present in the amount of 1 to 10 mole %.

In some embodiments, the copolyester compositions according to the present disclosure can optionally comprise from 0 to 10 mole %, for example, from 0 to 5 mole %, from 0 to 1 mole %, 0.01 to 5 mole %, from 0.01 to 1 mole %, from 0.05 to 5 mole %, from 0.05 to 1 mole %, or from 0.1 to 0.7 mole %, based on the total mole percentages of either the glycol or diacid residues; respectively, of one or more residues of a branching monomer, also referred to herein as a branching agent, having 3 or more carboxyl substituents, hydroxyl substituents, or a combination thereof. In certain embodiments, the branching monomer or agent may be added prior to and/or during and/or after the polymerization of the copolyester. In some embodiments, the copolyester(s) useful in the present disclosure can thus be linear or branched.

Examples of branching monomers include, but are not limited to, multifunctional acids or multifunctional alcohols such as trimellitic acid, trimellitic anhydride, pyromellitic dianhydride, trimethylolpropane, glycerol, pentaerythritol, citric acid, tartaric acid, 3-hydroxyglutaric acid and the like. In one embodiment, the branching monomer residues can comprise 0.1 to 0.7 mole % of one or more residues chosen from at least one of the following: trimellitic anhydride, pyromellitic dianhydride, glycerol, sorbitol, 1,2,6-hexanetriol, pentaerythritol, trimethylolethane, and/or trimesic acid. The branching monomer may be added to the copolyester reaction mixture or blended with the copolyester in the form of a concentrate as described, for example, in U.S. Pat. Nos. 5,654,347 and 5,696,176, whose disclosure regarding branching monomers is incorporated herein by reference.

The copolyesters useful in the present disclosure can comprise at least one chain extender. Suitable chain extenders include, but are not limited to, multifunctional (including, but not limited to, bifunctional) isocyanates, multifunctional epoxides, including, for example, epoxylated novolacs, and phenoxy resins. In certain embodiments, chain extenders may be added at the end of the polymerization process or after the polymerization process. If added after the polymerization process, chain extenders can be incorporated by compounding or by addition during conversion processes such as injection molding or extrusion.

The amount of chain extender used can vary depending on the specific monomer composition used and the physical properties desired but is generally about 0.1 percent by weight to about 10 percent by weight, such as about 0.1 to about 5 percent by weight, based on the total weight of the copolyester.

It is contemplated that copolyester compositions useful in the present disclosure can possess at least one of the inherent viscosity ranges described herein and at least one of the monomer ranges for the copolyester compositions described herein, unless otherwise stated. It is also contemplated that copolyester compositions useful in the present disclosure can possess at least one of the Tg ranges described herein and at least one of the monomer ranges for the copolyester compositions described herein, unless otherwise stated. It is also contemplated that copolyester compositions useful in the present disclosure can possess at least one of the inherent viscosity ranges described herein, at least one of the Tg ranges described herein, and at least one of the monomer ranges for the copolyester compositions described herein, unless otherwise stated.

For embodiments of this disclosure, the copolyester compositions useful in this disclosure can exhibit at least one of the following inherent viscosities as determined in 60/40 (wt/wt) phenol/tetrachloroethane at a concentration of 0.25 g/50 ml at 25° C.: 0.50 to 1.3 dL/g; 0.50 to 1.25 dL/g; 0.50 to 1.2 dL/g; 0.50 to 1.0 dL/g; 0.50 to 0.90 dL/g; 0.50 to 0.80 dL/g; 0.55 to 0.80 dL/g; 0.58 to 0.80 dL/g; 0.60 to 0.80 dL/g; 0.65 to 0.80 dL/g; 0.70 to 0.80 dL/g; 0.50 to 0.75 dL/g; 0.55 to 0.75 dL/g; 0.58 to 0.75 dL/g; 0.60 to 0.75 dL/g; 0.60 to 0.70 dL/g; 0.58 to 0.70 dL/g; or 0.55 to 0.70 dL/g.

The glass transition temperature (Tg) of the copolyester compositions is determined using a TA DSC 2920 from Thermal Analyst Instrument at a scan rate of 20° C./min. The value of the glass transition temperature is determined during the second heat.

In certain embodiments, the molded articles of this disclosure comprise copolyester compositions wherein the copolyester has a Tg of 70 to 115° C.; 70 to 80° C.; 70 to 85° C.; or 70 to 90° C.; or 70 to 95° C.; 70 to 100° C.; 70 to 105° C.; 70 to 110° C.; 80 to 115° C.; 80 to 85° C.; or 80 to 90° C.; or 80 to 95° C.; 80 to 100° C.; 80 to 105° C.; 80 to 110° C.; 90 to 115° C.; 90 to 100° C.; 90 to 105° C.; 90 to 110° C. In certain embodiments, these Tg ranges can be met with or without at least one plasticizer being added during polymerization.

In one embodiment, the copolyester compositions useful in this disclosure produce side view stripes that are clear or visually clear. The term “visually clear” is defined herein as an appreciable absence of color, cloudiness, haziness, and/or muddiness, when inspected visually. In one embodiment, the copolyester compositions useful in this disclosure produce side view stripes that are transparent. The term “transparent” is defined herein as an appreciable absence of cloudiness, haziness, and/or muddiness, such that you can see through the material when inspected visually. These terms are used interchangeably herein. In one aspect the terms clear and/or transparent are defined as having low haze. In one embodiment, clear and/or transparent are defined as having a haze value of 20% or less. In one embodiment, clear and/or transparent are defined as having a haze value of 15% or less. In one embodiment, clear and/or transparent are defined as having a haze value of 10% or less. In one embodiment, clear and/or transparent are defined as having a haze value of 5% or less.

In one embodiment, the copolyesters can be produced by processes in homogenous solution, by transesterification processes in the melt, and by two phase interfacial processes. Suitable methods include, but are not limited to, the steps of reacting one or more dicarboxylic acids with one or more glycols at a temperature of 100° C. to 315° C. at a pressure of 0.1 to 760 mm Hg for a time sufficient to form a copolyester. See U.S. Pat. No. 3,772,405 for methods of producing copolyesters, the disclosure regarding such methods is hereby incorporated herein by reference.

The copolyester in general may be prepared by condensing the dicarboxylic acid or dicarboxylic acid ester with the glycol in the presence of a catalyst at elevated temperatures increased gradually during the course of the condensation up to a temperature of about 225° C. to 310° C., in an inert atmosphere, and conducting the condensation at low pressure during the latter part of the condensation, as described in further detail in U.S. Pat. No. 2,720,507 incorporated herein by reference herein.

In some embodiments, during the process for making the copolyester composition useful in the present disclosure, certain agents which colorize the polymer can be added to the melt including toners or dyes. In one embodiment, a bluing toner is added to the melt in order to reduce the b* of the resulting copolyester polymer melt phase product. Such bluing agents include blue inorganic and organic toner(s) and/or dyes. In addition, red toner(s) and/or dyes can also be used to adjust the a* color. Organic toner(s), e.g., blue and red organic toner(s), such as those toner(s) described in U.S. Pat. Nos. 5,372,864 and 5,384,377, which are incorporated by reference in their entirety, can be used. The organic toner(s) can be fed as a premix composition. The premix composition may be a neat blend of the red and blue compounds or the composition may be pre-dissolved or slurried in one of the copolyester's raw materials, e.g., ethylene glycol.

The total amount of toner components added can depend on the amount of inherent yellow color in the base copolyester and the efficacy of the toner. In one embodiment, a concentration of up to about 15 ppm of combined organic toner components and a minimum concentration of about 0.5 ppm can be used. In one embodiment, the total amount of bluing additive can range from 0.5 to 10 ppm. In an embodiment, the toner(s) can be added to the esterification zone or to the polycondensation zone. Preferably, the toner(s) are added to the esterification zone or to the early stages of the polycondensation zone, such as to a prepolymerization reactor. In some embodiments, the toner(s) can be added after polymerization as a compounded master batch.

In some embodiments, the copolyester compositions can also contain from 0.01 to 25% by weight of the overall composition common additives such as colorants, toner(s), dyes, mold release agents, flame retardants, plasticizers, glass bubbles, glass fiber, natural fiber, nucleating agents, friction modifier, stabilizers, including but not limited to, UV stabilizers, thermal stabilizers, and/or reaction products thereof, fillers, and impact modifiers. Examples of commercially available impact modifiers include, but are not limited to, ethylene/propylene terpolymers, functionalized polyolefins such as those containing methyl acrylate and/or glycidyl methacrylate, styrene-based block copolymeric impact modifiers, and various acrylic core/shell type impact modifiers. Residues of such additives are also contemplated as part of the copolyester composition.

In some embodiments, the copolyester compositions contain additives to enable an opaque layer such colorants, pigments, dyes, fillers, opacifiers, talc, titanium dioxide, calcium carbonate. The opacifying additives are added in an amount from 0.1 to 10 wt % based on the overall weight of the composition.

Reinforcing materials may be added to the compositions useful in this disclosure. The reinforcing materials may include, but are not limited to, carbon filaments, silicates, mica, clay, talc, titanium dioxide, Wollastonite, glass flakes, beads and fibers, natural fibers, and polymeric fibers and combinations thereof. In one embodiment, the reinforcing materials include glass, such as, fibrous glass filaments, mixtures of glass and talc, glass and mica, and glass and polymeric fibers.

In one aspect of the present disclosure, the copolyester compositions further comprise recycled polyethylene terephthalate (rPET) or recycled polyesters. It is desirable that recycled PET (rPET) or recycled polyesters be incorporated back into new molded or extruded articles. Use of rPET or recycled polyesters lowers the environmental footprint of a product offering and improves the overall life-cycle analysis. The use of rPET or recycled polyesters offers economic advantages, and it would reduce the overall amount of packaging-related products sent to landfills or that could potentially end up contaminating oceans or other bodies of water.

There is no limitation on the recycled polyethylene terephthalate (rPET) or recycled polyesters that may be used in the to make blends with the copolyester compositions of the present disclosure. In one embodiment the rPET or recycled polyesters are mechanically recycled. In one embodiment the rPET or recycled polyesters are produced from chemically recycled monomers (produced by any known methods of depolymerization).

In one embodiment, the rPET may have minor modifications such as with up to 5 mole % of isophthalic acid and/or up to 5 mole % of CHDM or other diols. In one embodiment, the recycled PET (rPET) can be virtually any “waste” industrial or post-consumer PET. In one embodiment, the rPET useful in the blend compositions of the present disclosure may be post-consumer recycled PET. In one embodiment, the rPET is post-industrial recycled PET. In one embodiment, the rPET is post-consumer PET from soft drink bottles. In one embodiment, scrap PET fibers, scrap PET films, and poor-quality PET polymers are also suitable sources of rPET. In one embodiment, the recycled PET comprises substantially PET, although other copolyesters can also be used, particularly where they have a similar structure as PET, such as PET copolymers or the like. In one embodiment, the rPET is clean. In one embodiment, the rPET is substantially free of contaminants. In one embodiment, the rPET may be in the form of flakes.

In one embodiment, the copolyester compositions comprise 0 to 50 wt % of rPET. In one embodiment, the copolyester compositions comprise 1 to 40 wt % of rPET. In one embodiment, the copolyester compositions comprise 2 to 30 wt % of rPET. In one embodiment, the copolyester compositions comprise 3 to 20 wt % of rPET. In one embodiment, the copolyester compositions comprise 4 to 15 wt % of rPET. In one embodiment, the copolyester compositions comprise 5 to 10 wt % of rPET.

In one embodiment, up to about 50% by weight of rPET can be incorporated into the copolyester compositions of the present disclosure. In one embodiment, the rPET/copolyester blend is 15-50 wt % of rPET. In one embodiment, the rPET/copolyester blend is 25-40 wt % of rPET. In one embodiment, the rPET/copolyester blend is 20-30 wt % of rPET. In one embodiment rPET/copolyester blend is 15-50 wt % of rPET and 50-85 wt % of at least one copolyester.

The copolyester/rPET blends can be prepared by conventional processing techniques known in the art, such as melt blending, melt mixing, compounding via single screw extrusion, compounding via twin-screw extrusion, batch melt mixing equipment or combinations of the aforementioned. In one embodiment, the copolyester/rPET blends are compounded at temperatures of 220-320° C. In one embodiment, the copolyester/rPET blends are compounded at temperatures of 220-300° C. In one embodiment, the copolyester/rPET blends can be pre-dried at 60-160° C. In one embodiment, the copolyester/rPET blends are not pre-dried. In one embodiment, the compounding can occur under vacuum. In one embodiment, the compounding does not occur under vacuum.

Examples of molded articles include without limitation: containers, bottles, bottles with through-handles, medical devices, medical packaging, healthcare supplies, commercial foodservice products such as, containers, tumblers, storage boxes, bottles, appliance parts, utensils, water bottles.

In embodiments, the films and/or sheets of the present disclosure can be of any thickness as required for the intended application.

This disclosure further relates to the molded or shaped articles described herein. The methods of forming the copolyester compositions into molded or shaped articles includes any known methods in the art. Examples of molded or shaped articles of this disclosure including but not limited to thermoformed or thermoformable articles, injection molded articles, extrusion molded articles, injection blow molded articles, injection stretch blow molded articles and extrusion blow molded articles. Methods of making molded articles include but are not limited to thermoforming, injection molding, extrusion, injection blow molding, injection stretch blow molding, and extrusion blow molding. The processes of this disclosure can include any thermoforming processes known in the art. The processes of this disclosure can include any blow molding processes known in the art including, but not limited to, reheat blow molding, extrusion blow molding, extrusion stretch blow molding, injection blow molding, and injection stretch blow molding.

This disclosure includes any extrusion blow molding (EBM) manufacturing process known in the art. Although not limited thereto, a typical description of extrusion blow molding manufacturing process involves: 1) melting the composition in an extruder; 2) extruding the molten composition through a die to form a tube of molten polymer (i.e. a parison); 3) clamping a mold having the desired finished shape around the parison; 4) blowing air into the parison, causing the extrudate to stretch and expand to fill the mold; 5) cooling the molded article; 6) ejecting the article from the mold; and 7) removing excess plastic (commonly referred to as flash) from the article.

For example, in some embodiments, the polyester compositions of the present disclosure, can be dried in a desiccant dryer prior to molding, to reduce the moisture level in the polyester to levels below 200 ppm. Suitable extruders should be equipped with screws designed for PET, PVC, or PC, and the extrusion head should be designed for PET, PVC, or PC. A hot knife can be used, preferably a pre-squeeze, linear cut, or left-to-right can be used, however a front-to-back is also suitable for use and can be used in some embodiments as well. Mold design require good cooling and very sharp pinches. Suitable processing temperatures include 230-260° C. polymer melt, 220-250° C. barrel, and 230-260° C. extrusion head.

In one embodiment, the molded articles and parts of the present disclosure can be of any thickness required for the intended end use application. In one embodiment, the thickness of the molded articles and parts of the present disclosure are up to about 1 mm. In one embodiment, the thickness of the molded articles and parts is from about 0.1 mm-1 mm. In one embodiment, the thickness of the molded articles and parts is from 0.2 mm-0.5 mm. In one embodiment, the thickness of the molded articles and parts is from 0.25-0.35 mm.

In one embodiment, the width of the side view stripe can be of any width required for the intended end use application. In one embodiment, the width of the side view stripe is up to about 10 mm. In one embodiment, the width of the side view stripe is from about 1.0 mm-10 mm. In one embodiment, the width of the side view stripe is from 2 mm-8 mm. In one embodiment, the width of the side view stripe is from 3 mm-6 mm. In one embodiment, the width of the side view stripe is from 6 mm-9 mm. In some embodiments, the transparent side view stripe is marked to measure the contents.

The following examples further illustrate how the copolyesters of the present disclosure can be made and evaluated, and they are intended to be purely exemplary and are not intended to limit the scope thereof. Unless indicated otherwise, parts are parts by weight, temperature is in degrees C. (Celsius) or is at room temperature, and pressure is at or near atmospheric.

### EXAMPLES

This disclosure can be further illustrated by the following examples of preferred embodiments thereof, although it will be understood that these examples are included merely for purposes of illustration and are not intended to limit the scope of the disclosure unless otherwise specifically indicated.

The following describes the process used for the Examples.

View Stripe: Two extruders were connected to an extrusion blow molding machine, a large horizontal extruder for opaque material, and a smaller vertical extruder for transparent material. The opaque material was fed into the die head to create a hanging parison. The melted transparent material was inserted into the hanging parison resulting in a transparent stripe in the parison. Once the parison reached the appropriate length a mold enclosed and a hot knife cuts the material in the mold from the extruding parison. The material in the mold was then blown into the desired shape and ejected and then the remaining material that was not part of the design was removed.

Multi-Layer: An extruder corresponding to each layer was connected to an extrusion blow molding machine, up to 7 layers are possible, as well as a smaller vertical extruder for transparent material. The opaque materials were fed into the appropriate layer of the specialized die head creating a multi-layer hanging parison. The melted transparent material was inserted into the hanging parison and resulted in a transparent stripe in the parison. Once the parison reached the appropriate length the mold enclosed and a hot knife cuts the material in the mold from the extruding parison. The material in the mold was blown into the desired shape and ejected and the remaining material that was not part of the design was removed.

The die diameter (Muller) used: 25 mm-650 mm

Transparency was measured according to ASTM Method D1003. The molded articles prepared from the copolyester compositions of the present disclosure have a diffuse transmittance value of less than about 10%, or less than about 5%, and or less than about 2%.

Melt viscosities were measured in accordance with ASTM D4440. A frequency scan of between 1 rad/sec and 400 rad/sec was employed. The melt viscosity at 1 rad/sec is correlated to the “melt strength” of the polymer. The copolyesters of the present disclosure have a melt viscosity at the “minimum processing temperature” of at least 20,000 poise.

Inherent viscosities (I.V., dL/g) were measured at 25° C. using 0.5 g polymer per 100 mL of a solvent consisting of 60 parts by weight phenol and 40 parts by weight tetrachloroethane. Copolyesters of the present disclosure should have inherent viscosity (I.V.) values of about 0.5 to about 1.3 dL/g.

Crystalline melt temperatures were determined using differential scanning calorimetry in accordance with ASTM D3418. A sample of 15.0 mg was sealed in an aluminum pan and heated to 290° C. at a rate of 10° C./minute. The sample was then cooled to below its glass transition temperature at a rate of about 320° C./minute to generate an amorphous specimen. The melt temperature, Tm, corresponds to the peak of the endotherm observed during the scan. Note that some copolyesters do not exhibit a melt temperature as defined by this method. The melt temperature of a copolyester helps define the “minimum processing temperature” of the copolyester. In some embodiments, the copolyester compositions of the present disclosure have melt temperatures (Tm) of between about 225° C. to 255° C. as determined by Differential Scanning Calorimetry (DSC) (ASTM D3418) at a scan rate of 10° C./min.

TABLE 1

| | High Pressure | Melting Point |
|---|---|---|
| Composition | HDT (° C.) | DSC (° C.) |
| CHDM-TMCD | 85 | N/A |
| CHDM-EG | 63 | N/A |
| EG-TMCD | 85 | N/A |
| RIC1 EG-CHDM | 64 | 225 |

Table 1 illustrates that certain compositions of the present disclosure containing TMCD have higher HDT values at 70 C or greater, and therefore they will exhibit improved dishwasher durability. The HDT testing is in accordance with ASTM D648 at 264 psi or 1.8 mega pascals. The EG-CHDM compositions have the proper melting temperatures for RIC-1 compatibility.

TABLE 2

| | Zero Shear | Zero Shear | |
|---|---|---|---|
| | Viscosity | Viscosity | |
| | @230° C. | @260° C. | |
| Composition | (poise) | (poise) | Measurement |
| CHDM- | 83,540 | 24,510 | Capillary, TTS |
| TMCD | | | |
| CHDM-EG | 74,660 | 28,640 | Parallel Plate |
| EG-TMCD | 85,400 | 25,550 | Capillary, TTS |

Table 2 illustrates that the copolyester compositions of the present disclosure have zero shear viscosities in the proper range resulting in good melt strength to enable good EBM processability.

EBM process: For the CHDM-EG composition, a Bekum H-155 extrusion blow molding (EBM) Machine equipped with a 90 mm smooth barrel extruder (Extruder 1) with an HDPE feed screw and screen changer with 20 mesh screen was used, as well as a 20 mm grooved barrel vertical extruder (Extruder 2) and a BKZ120.1VS extrusion head with a 16 oz stock bottle mold and blow pin with a front to back hot knife. Grooved feed sections in extruders are commonly used with HDPE to improve output, however the harder nature of the copolyester pellets can make it difficult to use this type of equipment. Therefore, Extruder 2 had to be starve fed to reduce torque and motor load. Additional settings had to be modified to allow for high temperature deltas and lower screw speeds. All material was dried in a Whitmann Drymax Aton F70 desiccant dryer overnight. CHDM-EG was dried at 60° C., while CHDM-TMCD was dried at 77° C.

The following are the molding parameters used with CHDM-EG. Extruder 1 was operated with a 966 PSI pressure, a 149.98 RPM motor speed, a 5.5 RPM screw speed, and a 45% load. The temperatures were, from Zones 1-7 respectively, 208° C., 219° C., 218° C., 211° C., 210° C., 210° C., and 210° C. The Extrusion head was operated with temperatures from Zones 8-11 respectively, 222° C., 221° C., 221° C., and 221° C. The Sight Stripe Adaptor was operated with a 221° C. temperature in Zone 18. Extruder 2 was operated with a 128.62 RPM motor speed, 8.1 RPM screw speed, and a 70% load. The temperatures were, from Zones 19-22 respectively, 232° C., 232° C., 232° C., and 232° C.

The following are the molding parameters used with CHDM-TMCD. Extruder 1 was operated with an 1165 PSI pressure, a 169.68 RPM motor speed, a 6.18 RPM screw speed and a 49.7% load. The temperatures were, from Zones 1-7 respectively, 233° C., 239° C., 239° C., 232° C., 232° C., 232° C., and 232° C. The Extrusion head was operated with temperatures from Zones 8-11 respectively, 222° C., 221° C., 221° C., and 221° C. The Sight Stripe Adaptor was operated with a 221° C. temperature in Zone 18. Extruder 2 was operated with a 238.31 RPM motor speed, a 14.98 RPM screw speed, and a load of 61.58%. The temperatures were, from Zones 19-22 respectively, 238° C., 238° C., 238° C., and 232° C.

The present invention is illustrated in greater detail by the specific examples presented below. It is to be understood that these examples are illustrative embodiments and are not intended to be limiting of the invention, but rather are to be construed broadly within the scope and content of the appended claims.

1. A multi-layer extrusion blow molded article with a transparent view panel which comprises at least one opaque layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of 1,4-cyclohexanedimethanol; and
(iii) 0 to 10 mole % residues of other modifying glycols chosen from one or more of the following diethylene glycol, NPG, TMCD, MPDiol, isosorbide, butane diol, propane diol;
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %; and
at least one transparent layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of 1,4-cyclohexanedimethanol; and
(iii) 0 to 10 mole % residues of other modifying glycols chosen from one or more of the following diethylene glycol, NPG, TMCD, MPDiol, isosorbide, butane diol, propane diol;
(c) optionally, at least one branching agent in the amount of 0 to 1.0 mole %; and
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; and wherein said transparent view panel has a haze value of less than 10%, when measured on a film 16 mils thick, as measured by ASTM D1003, Method A.

2. A multi-layer extrusion blow molded article with a transparent view panel which comprises at least one opaque layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of TMCD; and
(iii) 0 to 10 mole % residues of other modifying glycols chosen from one or more of the following diethylene glycol, NPG, CHDM, MPDiol, isosorbide, butane diol, propane diol;
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %; and
at least one transparent layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of TMCD; and
(iii) 0 to 10 mole % residues of other modifying glycols chosen from one or more of the following diethylene glycol, NPG, CHDM, MPDiol, isosorbide, butane diol, propane diol;
(c) optionally, at least one branching agent in the amount of 0 to 1.0 mole %;
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; and wherein the Tg of the polyester is from 80° C. or greater; and wherein said article is opaque and has a transparent view panel and wherein said transparent view panel has a haze value of less than 10%, when measured on a film 16 mils thick, as measured by ASTM D1003, Method A.

3. A multi-layer extrusion blow molded article with a transparent view panel which comprises at least one opaque layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % CHDM residues; and
(ii) 0 to 75 mole % residues of TMCD; and
(iii) 0 to 10 mole % residues of other modifying glycols chosen from one or more of the following ethylene glycol, diethylene glycol, NPG, TMCD, MPDiol, isosorbide, butane diol, propane diol;
(c) optionally, at least one branching agent in the amount of 0 to 1.0 mole %;
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %; and wherein the Tg of the polyester is from 80° C. or greater;
and
at least one transparent layer which comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % CHDM residues; and
(ii) 0 to 75 mole % residues of TMCD; and
(iii) 0 to 10 mole % residues of other modifying glycols chosen from one or more of the following ethylene glycol, diethylene glycol, NPG, TMCD, MPDiol, isosorbide, butane diol, propane diol;
(c) optionally, at least one branching agent in the amount of 0 to 1.0 mole %;
wherein the total mole % of the dicarboxylic acid component is 100 mole %, and
wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° C.; and wherein the Tg of the polyester is from 80° C. or greater; and wherein said transparent view panel has a haze value of less than 10%, when measured on a film 16 mils thick, as measured by ASTM D1003, Method A.

4. The article of claim 1, wherein said polyester composition has zero shear viscosity of 6000-9000 pascal-seconds at 230° C. or 2000-4000 pascal-seconds at 260° C.

5. The article of claim 1, wherein said transparent view panel has a haze value of less than 5%; or wherein said transparent view panel has a haze value of less than 3%.

6. The article of claim 1, wherein the branching agent is present in the amount of 0 to 0.6 weight % based on the total weight of the polyester; or wherein the branching agent present in the amount of 0 to 0.2 weight % based on the total weight of the polyester; and wherein the branching agent is chosen from at least one of the following trimellitic acid, trimellitic anhydride, trimethylolpropane, pentaerythritol, and/or trimethylolethane.

7. The article of claim 1, wherein the inherent viscosity of the polyester is from 0.60 to 1.25 dL/g.

8. The article of claim 1, wherein the high pressure HDT of the article is 70° C. or greater, or 80° C. or greater or 85° C. or greater, or 90° C. or greater.

9. The article of claim 1, wherein the Tg of the polyester is from 75° C. or greater, or from 80° C. or greater, or from 90° C. or greater, or from 95° C. or greater, or from 100° C. or greater, or from 105° C. or greater, or from 110° C. or greater.

10. The article of claim 1, further comprising at least one additive chosen from colorants, mold release agents, phosphorus compounds, plasticizers, nucleating agents, friction modifiers, UV stabilizers, glass fiber, carbon fiber, natural fibers, impact modifiers, or a mixture thereof.

11. The article of claim 1, which comprises a container; or which comprises a bottle.

12. The article of claim 1, further comprising at least one polyester with recycle content.

13. The article of claim 1, wherein the EG is recycled EG (rEG); and/or wherein the CHDM is rCHDM or the CHDM produced from rDMT; and/or wherein the TMCD is rTMCD; and/or wherein the DEG is recycled DEG or the DEG is produced from rEG.

14. The article of claim 1, wherein the transparent layer further comprises rPET.

15. The article of claim 1, wherein the polyester has 0-10 wt % total comonomer content from glycols and acids other than ethylene glycol (EG), terephthalic acid (TPA), or dimethyl terephthalate (DMT) or any combinations thereof must be less than 10 wt %.

16. The article of claim 15, wherein the article has a melting temperature (Tm) of 225-255° C.

17. The article of claim 15, wherein the article is recyclable in a PET recycle stream.

18. The article of claim 1, wherein the article has a thickness of from 0.1 mm-1.0 mm.

19. The article of claim 1, wherein the view stripe has a thickness of from 1 mm-10 mm.

20. A multi-layer extrusion blow molded container comprising a cavity that is configured and adapted to hold liquid, the container having a horizontal perimeter and comprising an opaque wall portion and transparent wall portion, the opaque wall portion comprising at least one layer extending a majority of the way around the perimeter and bounding a main portion of the cavity, the transparent wall portion comprising at least one layer extending beyond the opaque wall portion and vertically along the opaque wall portion of the container in a manner such that liquid in the cavity can be observed through the transparent wall portion said at least one opaque layer comprises at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of 1,4-cyclohexanedimethanol; and
(iii) 0 to 10 mole % residues of other modifying glycols chosen from one or more of the following diethylene glycol, NPG, TMCD, MPDiol, isosorbide, butane diol, propane diol; or
(b′) a glycol component comprising:
(i) 25 to 100 mole % ethylene glycol residues; and
(ii) 0 to 75 mole % residues of TMCD; and
(iii) 0 to 10 mole % residues of other modifying glycols chosen from one or more of the following diethylene glycol, NPG, CHDM, MPDiol, isosorbide, butane diol, propane diol; or
(b″) a glycol component comprising:
(i) 25 to 100 mole % CHDM residues; and
(ii) 0 to 75 mole % residues of TMCD; and
(iii) 0 to 10 mole % residues of other modifying glycols chosen from one or more of the following ethylene glycol, diethylene glycol, NPG, TMCD, MPDiol, isosorbide, butane diol, propane diol; and
(c) optionally, at least one branching agent in the amount of 0 to 1.0 mole %; and
(d) at least one additive chosen from one or more of colorants, pigments, dyes, fillers, opacifiers, talc, titanium dioxide, calcium carbonate in the amount of 0.1 to 10 wt %; and
wherein the total mole % of the dicarboxylic acid component is 100 mole %, and wherein the total mole % of the glycol component is 100 mole %; and wherein the Tg of the polyester is from 80° C. or greater;
and
said at least one transparent layer comprising at least one polyester composition comprising:
(a) a dicarboxylic acid component comprising:
(i) about 90 to about 100 mole % of terephthalic acid residues;
(ii) about 0 to about 10 mole % of aromatic and/or aliphatic dicarboxylic acid residues having up to 20 carbon atoms; and
(b) a glycol component comprising:
(i) 25 to 100 mole % ethylene glycol residues; and
(ii) 0 to 75 mole % residues of 1,4-cyclohexanedimethanol; and
(iii) 0 to 10 mole % residues of other modifying glycols chosen from one or more of the following diethylene glycol, NPG, TMCD, MPDiol, isosorbide, butane diol, propane diol; or
(b′) a glycol component comprising:
(i) 25 to 100 mole % ethylene glycol residues; and
(ii) 0 to 75 mole % residues of TMCD; and
(iii) 0 to 10 mole % residues of other modifying glycols chosen from one or more of the following diethylene glycol, NPG, CHDM, MPDiol, isosorbide, butane diol, propane diol; or
(b″) a glycol component comprising:
(i) 25 to 100 mole % CHDM residues; and
(ii) 0 to 75 mole % residues of TMCD; and
(iii) 0 to 10 mole % residues of other modifying glycols chosen from one or more of the following ethylene glycol, diethylene glycol, NPG, TMCD, MPDiol, isosorbide, butane diol, propane diol;
(c) optionally, at least one branching agent in the amount of 0 to 1.0 mole %; and
wherein the total mole % of the dicarboxylic acid component is 100 mole %, and wherein the total mole % of the glycol component is 100 mole %; and
wherein the inherent viscosity of the polyester is from 0.50 to 1.30 dL/g as determined in 60/40 (wt/wt) phenol/tetrachloroethane at a concentration of 0.25 g/50 ml at 25° A=πr²C.; and wherein said transparent view panel has a haze value of less than 10%, when measured on a film 16 mils thick, as measured by ASTM D1003, Method A; and wherein the Tg of the polyester is from 80° C. or greater.
